(19) United States
(12) Patent Application Publication
(10) Pub. No.: US 2014/0295401 A1
(43) Pub. Date: Oct. 2, 2014

(54) PLATFORM AND METHOD FOR AUTOMATED PHONE EDUCATION

(71) Applicant: MATTHEW LAWRENCE AHART, ENCINO, CA (US)

(72) Inventor: MATTHEW LAWRENCE AHART, ENCINO, CA (US)

(21) Appl. No.: 14/303,444

(22) Filed: Jun. 12, 2014

Related U.S. Application Data
(63) Continuation of application No. 12/118,762, filed on May 12, 2008.

(51) Int. Cl. G09B 19/18

(52) U.S. Cl. CPC G09B 19/18
USPC 434/362

(57) ABSTRACT

A platform and method for providing telephonic education. The platform utilizes a telephone-server connection to provide automated registration, payment, course materials, and sending of a notice of completion.

### CROSS-REFERENCE TO RELATED APPLICATIONS

Not applicable.

### FIELD OF THE INVENTION

The present invention relates to the provision of educational content. Specifically, the present invention relates to the provision of education involving telephones and the internet.

### FEDERALLY SPONSORED RESEARCH

Not applicable.

### SEQUENCE LISTING OR PROGRAM

Not applicable.

### BACKGROUND OF THE INVENTION

In 2005, President Bush signed into law the Bankruptcy Abuse Prevention and Consumer Protection Act (BAPCPA). This law addressed what was perceived as abuse in bankruptcy filings and a general lack of education among persons filing for bankruptcy.

In particular, the law imposed two new requirements of credit counseling and debtor education which apply to selected individuals filing for bankruptcy protection. The credit counseling requirement obligates debtors to speak with a credit counseling agency about their financial situation before filing for bankruptcy. After filing for bankruptcy, debtors are required to take a two-hour course in personal financial management as their debtor education requirement.

These requirements, as enacted, are now written into the U.S. law at 11 U.S.C. §§109(h), 111, 727, and 1328. Section 109(h)(1) discusses who may be a debtor and provides in pertinent part, “Subject to paragraphs (2) and (3), and notwithstanding any other provision of this section, an individual may not be a debtor under this title unless such individual has, during the 180-day period preceding the date of filing of the petition by such individual, received from an approved nonprofit budget and credit counseling agency described in section 111 (a) an individual or group briefing (including a briefing conducted by telephone or on the Internet) that outlined the opportunities for available credit counseling and assisted such individual in performing a related budget analysis.” Section 109(h)(4) discusses exemptions from the credit counseling requirement for persons who are incapacitated, disabled or actively serving in the military in a combat zone.

Section 111, entitled “Nonprofit budget and credit counseling agencies; financial management instructional courses”, discusses who may provide credit counseling and debtor education for bankruptcy. Subparagraph 111(d)(1)(C) contemplates education via the internet or telephone (“facilities may include the provision of such instructional course by telephone or through the Internet, if such instructional course is effective”).

Debtors can now complete their educational requirements either in person, via the internet, or over the phone. Where they complete the course over the internet, some providers provide the entire course over the internet, so debtors can pay (e.g., by credit card, debit card or electronic check), enter information (if necessary) for the course, review course materials, answer questions, and fill out an evaluation all on-line. The provision of this course can be fully automated (see, for example, Sage Personal Finance's course, available at www.sagepf.com).

Although the internet-based education can be completely automated, many debtors choose to complete their education over the telephone. For credit counseling, this usually entails arranging an interview, calling and speaking with a live credit counselor over the phone, and completing the entire education speaking with and listening to a live person. Use of a live person over the phone drives up the costs of agencies' provision of credit counseling services.

For debtor education, many providers provide the course “over the phone”. Although each provider's service is slightly different, this process usually involves: (1) having a debtor register and pay, (2) mailing of materials to the debtor, (3) having the debtor call and speak one-on-one or listen-in as part of a group conference call with a live counselor, and then (4) receive the certificate after submitting a fax number, email address or postal address. The provision of a phone course in this manner is expensive because a live counselor is required. In addition, the requirement of pre-registration slows down the process. In addition, because live personnel are involved in the provision of the course, human error will creep in to the process. This human error can result in mistranslation of fax numbers, email address or postal addresses—resulting in certificates being sent to the wrong place (or non-existence places). In addition, the use of a human slows the process down because certificates which are to be generated using the EOUST certificate-generation system are not generated automatically. Also, because one or all of accepting payment, provision of the course, or the creation of certificates requires a person to be present, a course cannot be made available 24-hours-a-day, 7-days-a-week unless personnel are working for the course all the time, which drives up the cost of providing such a course.

It is desirable to implement a “phone course” that utilizes a high degree of automation to decrease cost, increase reliability, accelerate the process, and allow complete on-demand provision of bankruptcy education services.

### EOUST/Bankruptcy Administrators

Since April 2005, the Executive Office for U.S. Trustees (EOUST) a branch of the United States Department of Justice, has served as the regulator for credit counseling agencies and debtor education providers for bankruptcy. EOUST has promulgated rules and proposed rules relating to the provision of these educational requirements, which are available from EOUST's website at www.usdoj.gov/ust.

In addition to these rules, EOUST's website provides answers to questions relating to bankruptcy education and also has downloadable pdf forms relating to application for approval for credit counseling agencies and debtor education providers.

In the federal judicial districts of Alabama and North Carolina, entities called Bankruptcy Administrators regulates bankruptcy education companies. The Bankruptcy Administrators serve a similar function as that of the EOUST for the purposes of bankruptcy education.

When a debtor completes his/her educational course, agencies/providers provide the debtor with a certificate of completion. For debtors in EOUST jurisdictions, bankruptcy education companies can log-in to a secure website operated by the EOUST and use that website to generate official certificates of completion in pdf format. These official certificates include the following information: certificate number, method of delivery (phone, internet, in person), name of agency/provider, name of debtor, case number, judicial district.

In a debtor education or credit counseling system, it is desirable to integrate with the EOUST certificate-generation website so reliably and expediently generate certificates of completion.

### PACER

Many debtors do not know their case numbers, federal judicial districts or the fax numbers or email addresses of their lawyers. However, this information is needed to create a certificate of completion and also for a debtor education or credit counseling provider to know that it is approved to operate for a given debtor. Thus, there may be a need to look up court records to find a case number of judicial district for a given debtor.

The United States Judiciary provides a system that provides electronic access to court records. This system is called Public Access to Court Electronic Records (PACER). Public Access to Court Electronic Records (PACER) is an electronic public access service that allows users to obtain case and docket information from Federal Appellate, District and Bankruptcy courts, and from the U.S. Party/Case Index via the Internet Links to all courts are provided from this web site. Electronic access is available by registering with the PACER Service Center, the judiciary's centralized registration, billing, and technical support center.

Each court maintains its own databases with case information. Because PACER database systems are maintained within each court, each jurisdiction will have a different URL. Accessing and querying information from each service is comparable; however, the format and content of information provided may differ slightly.

For debtors in bankruptcy, PACER will contain some or all of the following information about each bankruptcy case: debtor's name, joint or individual bankruptcy, debtor address, debtor phone number, bankruptcy chapter (usually 7 or 13 for individuals), lawyer name, lawyer address, lawyer email, lawyer fax number, lawyer phone number, date of bankruptcy filing, and the list of documents in a bankruptcy case (“docket”) with links to these documents.

PACER is accessible via traditional internet browser. Since each judicial district has its own independent website, links to these websites have been compiled at http://pacer.pse.uscourts.gov/psco/egi-bin/links.pl. Individual judicial district PACER websites can be searched using a “query” on any or all of Case Number, Last/Business Name, First Name, Middle Name, Social Security Number, Tax ID, and Type (Attorney, Creditor, Party, Professional, Trustee, U.S. Trustee).

In addition, PACER also provides a U.S. Party/Case Index. This is an index of all cases throughout the many judicial districts and is available at http://pacer.uspci.uscourts.gov/. The U.S. Party/Case Index is searchable using Region (All Courts, Judicial Circuit, State, Judicial District), Filing Date for a bankruptcy case, Party Name (e.g., name of debtor(s)), Last Four Digits of Debtor's Social Security Number, Debtor's Social Security Number, and Case Number.

The courts charge a fee for use of the PACER system, and a userid and password are required to login.

### SUMMARY OF THE INVENTION

The present invention is an automated system whereby education is provided to a user over the phone. In particular, it is anticipated that this system is particularly desirable for use with bankruptcy education. Although the bankruptcy education requirements were introduced in April 2005 legislation, no entity currently provides an automated system for phone-based bankruptcy education. It is anticipated that this automated system will be particularly desirable for elderly individuals who do not regularly use computers or the internet, but desire the advantages of speed, consistency and cost-effectiveness that an automated phone course can provide.

Under the present invention, an individual desiring to use a telephone to access educational content dials a telephone number. The telephone number is answered by a platform that provides educational content. The platform may look up a user in a list of potential users, such as a list of persons enrolled in a class, a list of persons filing for bankruptcy, a list of traffic violators for traffic school, or any other list that may be useful. This lookup can be accomplished in response to basic user input, such as a name, identifying numbers, or a combination thereof. Alternatively, the platform can register a new user where the user is not found in a list that it may consult, or where the platform does not use a lookup function.

A user may pay for the educational content by inputting payment information via the telephone. Payment can be made by credit card, debit card, electronic check. Alternatively, payment may be prearranged or a bill may be sent to the user after completion of the course.

A user listens to educational content that is provided via the telephone. This is much like listening to an audio lecture. A user may have the option to pause, rewind, fast-forward, or repeat content.

A user's progress can be saved in a database. This progress can be saved at the end of a course module, or after a prearranged period of time, such as every five minutes. By saving a user's progress, a user can stop and call back to continue the course later. A returning user may pick up where (s)he left off, either from the beginning of the module not completed, or possibly from the exact moment (s)he left the course last, depending on how the system is setup.

If the course is administered in a series of modules, it may be desirable to allow the user to pause, stop and exit, or save progress after each module. If the course is administered in multiple modules, each module can be a separate sound file.

After listening to course content, a user may answer a series of questions relating to the course. These questions could be a “quiz” to rate what the user learned. Alternatively, the questions could be an evaluation to get feedback from the user (e.g., how well the user liked the course). The answers to these questions can be saved in the database for analysis. Where more than one module is used, questions could be administered after each module, or at the end, or both.

When a user is complete, the user is notified that (s)he has finished the course and evidence of completion is provided to him/her. Such evidence of completion can be a statement or letter that states that there is completion, or a form that may be standardized or issued by a regulating agency. Notice of completion can be provided to the user in a number of ways. The notice can be played to the user, with all information heard by the user. Alternatively, the notice can be sent to the user by e-mail or fax. Or, the notice can be mailed using the postal service. Finally, the notice can be provided to third parties who may be interested, such as a lawyer, department of motor vehicles, administrative clerk that tracks performance, school administrator, bankruptcy court, bankruptcy trustee, or representative of the educational institution that is providing the course.

Using current internet-related and telecommunications technology, all or some of the above can be automated. This automation can reduce the cost of providing education, the time required to complete such education, and the number of errors associated with registering and sending notices.

In addition, although this summary describes many desirous aspects of the invention, a platform may be created using less than all of these aspects and still be very desirable.

### BRIEF DESCRIPTION OF THE DRAWINGS

FIG. 1 shows a telephone keypad for entering information.

FIG. 2 is a schematic of the main (registration) menu in one embodiment of the invention.

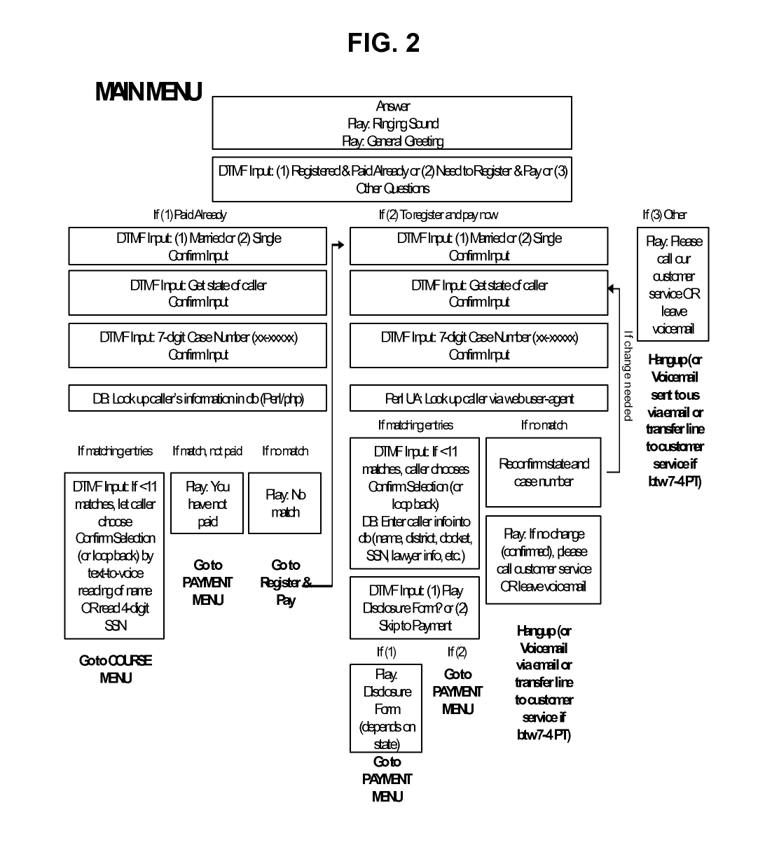

FIG. 3 is a schematic of the payment menu in one embodiment of the invention.

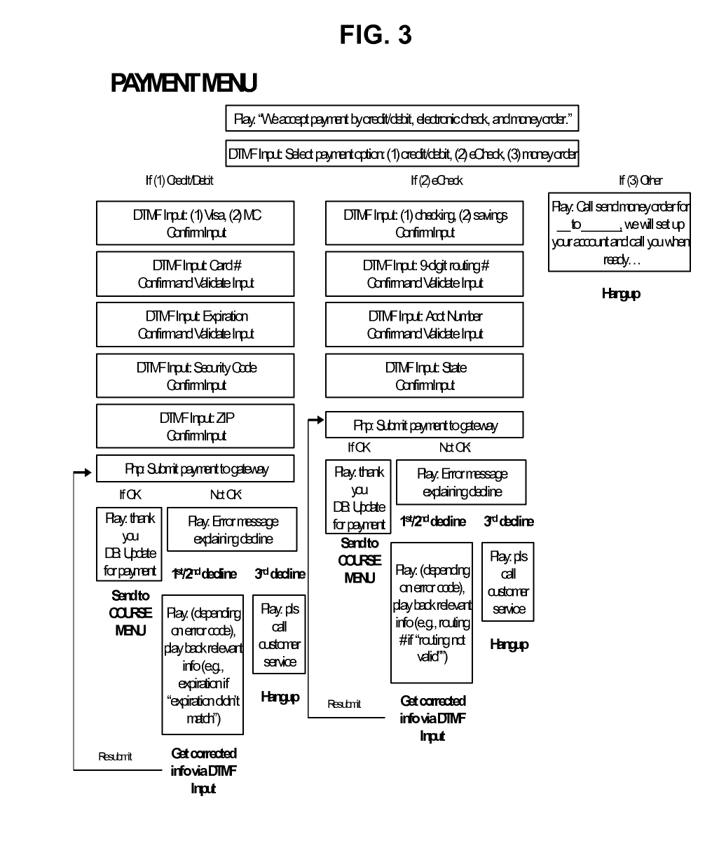

FIG. 4 is a schematic of the course menu in one embodiment of the invention.

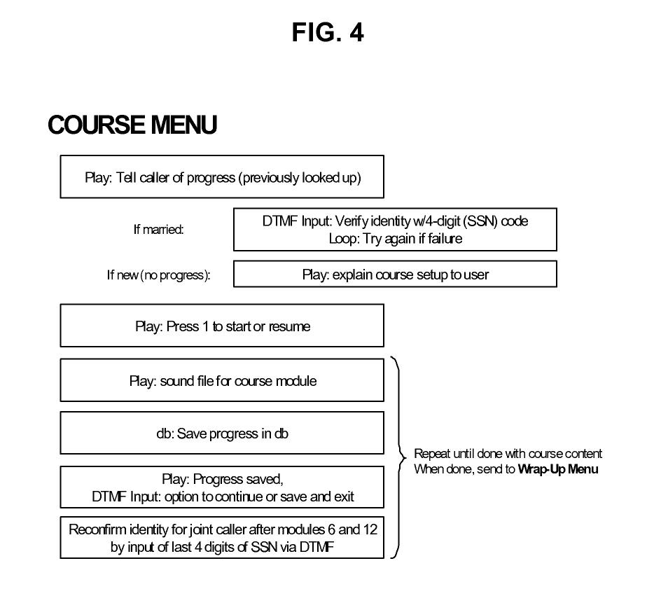

FIG. 5 is a schematic of the wrap-up menu in one embodiment of the invention.

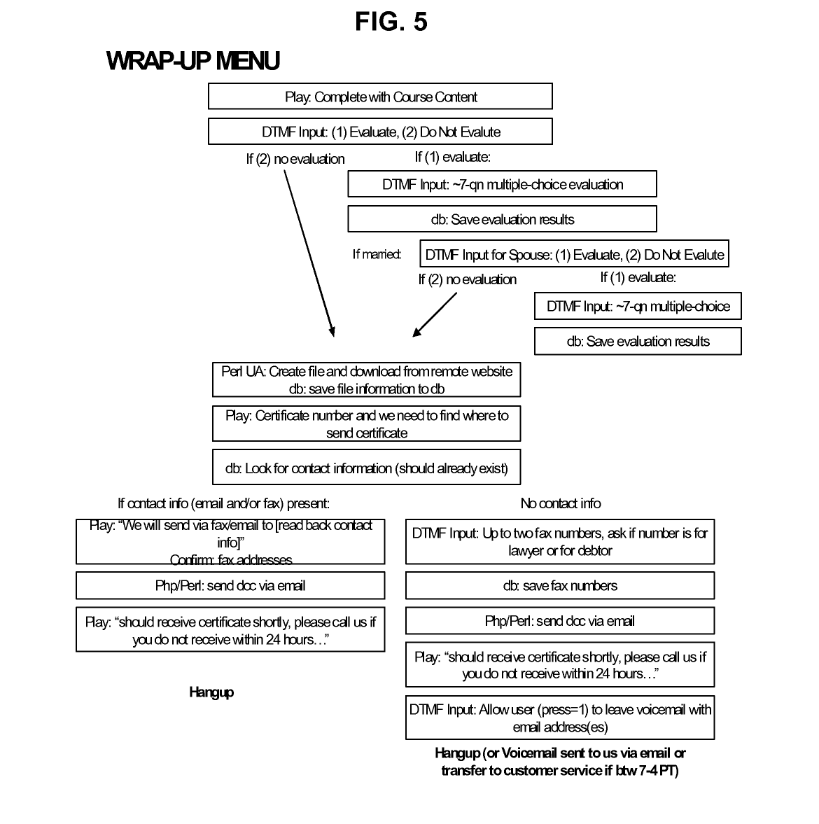

### DETAILED DESCRIPTION OF PREFERRED EMBODIMENTS

A phone course of this invention may provide all of the following steps in a format that does not require intervention of a live customer service person: registration, payment, course modules, evaluation, generating certificate of completion, sending certificate of completion.

### Registration

To register a debtor for the course, the service must determine the identity of the debtor in some manner, preferably such that the debtor's identity is unique. In the bankruptcy court system, debtor names are commonly used, as well as the final four digits (or the entirety) of the debtor's Social Security Number, the debtor's judicial district. It is also possible to use the state, the zip code, the street address, the phone number, fax number, or email address. Any of this information could correspond to the debtor or his/her attorney or other representative.

For a desired set of registration information, a debtor could enter this information via any of the DTMF input techniques described herein.

In addition, the PACER system can be used to provide registration information. For example, if a debtor identifies him/herself by district and case number, the debtor's lawyer's information can be looked up on PACER. A robot can be used to accomplish this, for example using Perl's LWP::User-Agent module or using Perl's Mechanize module.

### Payment

Payment is taken securely over the internet where payment is made using credit card, debit card and electronic check. The information that is required for payment can be reduced to numeric information. For example, for a credit card, it is desired to have the credit card number, expiration date (e.g., 6/11 for Jun. 2011), the 3- or 4-digit security code, and, possibly, the billing address ZIP code. This information can readily be inputted via DTMF input.

Once the information is input, it can be submitted to a payment gateway. This payment method is standard and commonly understood for internet companies. A payment gateway link AuthorizeNet can be used. The gateway will charge a fee and submit the payment information to a payment processor which will respond with a set of response codes. ModPay is a payment gateway that can be used for electronic check payments.

If the payment looks acceptable, a positive response (accept) will be returned from the payment gateway. This response may be parsed by the server and the user's information can be entered into the database or the user's information can be updated in the database to reflect successful payment.

For the foregoing payment discussion, all information was inputted in numeric format. Additional information, such as the cardholder name and street address may be desired and this information contains alphabetical format as well. The input techniques described earlier can be used to accept this information.

This invention may also be used whereby a debtor may speak with a customer service representative to register and/or pay.

Where payment is processed directly from the server to a payment gateway, such processing should be secure. A SSL certificate may be installed on the server to ensure security.

### Course Content

Once a customer has registered and paid, the customer will listen to a variety of course modules. These course modules contain the course content and are either (1) contained in sound files or (2) are contained in text format and are converted from text-to-speech.

A user's progress can be tracked in the database. This way if a user stops part way, he/she can return and pick up from where he/she left off or close to that. There is a trade-off between frequent saving of progress and excessive database interaction. For example, saving user progress after every second of progress would result in delay and excessive bandwidth used in transmitting information to the database. However, saving user input not at all means that the user who may have to stop to answer the door or go to the bathroom will not have his/her progress saved. Also, if the course modules are played in the form of sound files, it is difficult of implement a system that saves progress mid-way thorugh a sound file. It is anticipated that optimal saving of progress will be at the end of each sound file or approximately after every 5 minutes of progress.

Audio files can be stored on the same server that runs the PBX program or they can be remote, as long as they are accessible by the PBX program.

Furthermore, audio files may not be needed if a text-to-speech engine is used. In that circumstance, course content may be stored in text format and converted to speech by the text-to-speech engine.

### Evaluation

It may be desired to obtain an evaluation of the course from the user at or close to the end of the course. Such an evaluation can be introduced using multiple-choice questions or yes/no questions. If multiple-choice or yes/no questions are used, the user can use DTMF input to submit answers. For example, “1” can be pressed for “yes” and “2” for “no.” Or “1” for “a” and “2” for “b” and “3” for “c”, etc. Voice recognition can also be used (as it could for any input), if desired.

If the evaluation is desired to contain answers that can be anything, then the user can be prompted to verbally speak his/her answer. This answer can either be recorded for later playback or converted using a speech-to-text converter. Converters can be found using a Google search for “speech-to-text”, although any speech-to-text converter would have to be integrated into the phone course system herein described. Brothersoft.com, Wave to Text, NovuScript.com, and Dragon NaturallySpeaking are all speech-to-text converters that can be used.

### Generating Certificates of Completion

When the EOUST certificate generation portal is to be used, to allow for immediate creation of a certificate of completion, the system should be able to securely query the EOUST certificate generation website. Approved providers have login and password information that can be used to access the site. Once on the site, the user can navigate around the site and enter information to create a certificate.

A script can be written to perform this function. The inventor has written scripts that accomplish this using the LWP User-Agent module in Perl. This script creates a mock browser (robot) that can navigate the web. When finished, the robot can save certificate information into a database and also save the certificate itself into onto the server.

If a certificate of completion is not to be created using the EOUST certificate generation portal, a certificate can be created by the platform. Such a certificate can be a simple document, such as one in .pdf format. For example, the inventor has authored php scripts using a pdf-making application (R&OS Ltd's PHP Pdf Creation application, available at http://sourceforge.net/projects/pdf-php) to create pdf files for Bankrupty Administrator districts.

### Notice of Completion/Sending Certificates of Completion

It is desired to get the certificate information to the debtor and his/her lawyer, if any. Once a certificate is generated, the certificate number can be read by the robot and told to the debtor via the phone connection. Any other information, such as the name of the provider, the completion date, the completion time, the method of delivery, etc., can also be told to the debtor via the phone connection.

It is also desirable to send the certificate of completion to the debtor and his/her lawyer, if any. The certificate can be sent by email or fax. An email can be sent directly from the server using basic email-sending (MIME-format) utilities. In addition, a fax can be sent as an internet fax. A fax server can be connected to or a part of the server, allowing a fax to be sent electronically.

Alternatively, an internet fax account can be used, whereby an email is sent to a company and this company then converts the email received into a fax that is then sent. The inventor utilizes such an account with MyFax.com currently.

It may also be desired to send the certificate using the postal mail, in which case a physical print out of the certificate will have to be made. A service that converts email to letters can be used for this, if desired.

### User Input

To facilitate communication between a caller and a system, there must be a mechanism whereby input is taken from the caller. Input can be received from a caller using either voice recognition or input via a phone keypad (DTMF INPUT). This is also sometimes referred to as Touch-Tone® input. A user can enter numerical information by pressing numerical keys on his/her phone handset. When each key is pressed a tone corresponding to that key is transmitted. A receiver will hear the tone and translate it into the number that is entered (or a code designating that number).

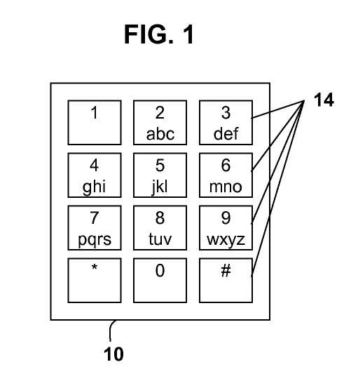

In addition, the keypad can also be used to transmit alphabetical (letter) information. This can be done by mapping the numbers on the keypad to the letters of the alphabet. One such example that is commonly understood is shown in FIG. 1.

Text-messaging techniques can be used. In one method, it is commonly understood when text-messaging that a user may rotate among the letters associated with a key. For example, pressing the “2” key once corresponds to “a”, pressing twice corresponds to “b”, and pressing three times corresponds to “c”.

In another method, called T9word, a user will spell a word by pressing the keys corresponding to each letter and a program running dictionary algorithms will attempt to find the matching word. For example, a user could enter “223” which corresponds to any word spelled with a first letter of “a”, “b”, or “c”, a second letter of “a”, “b”, or “c”, and a third letter of “d”, “e, “f′. A list of words with letters matching the “223” code can be maintained in a database, along with the frequencies of their use.

Different matching algorithms can be utilized. The user could be prompted with the most commonly used word matching “223”, and the user can accept or reject. The accept/reject decision can be made by pressing a key (e.g., “*” to accept, and “#” to reject). If the most common word is rejected, then the next most common word may be suggested. For example, “223” corresponds to the following words “bad”, “ace”, “cad”, in order of their frequency. If bad is the most common word, then it would be suggested. If the user rejects “bad”, then “ace” would be suggested. If “ace” is rejected, then “cad” is suggested. Alternatively, the list of known words could be maintained and the words could be offered in alphabetical order. In this case, “ace” would be offered first, “bad” second, and “cad” last.

It is also possible to match by using a partial match. In this instance, “223” could correspond to any of the three-letter words discussed, or it could correspond to the first three letters of a word with more than three letters (such as “baffle”). A dictionary translating words to starting letter key-sequences could be used. This approach is less attractive where letters can correspond to any word, but this approach is effective when a limited known list of words is used. Such an example would be to specify a state of the United States. For example, a user seeking to enter “New Jersey” as his/her state could enter “639” for the first three letters and then the list of states starting with “639” could be used as suggestions. In this manner, the New Jersey user would not have to spell his/her entire state.

Another way to identify location information is to use numerical ZIP codes. For example, a user could enter a 5-digit ZIP code, and a lookup function could use this 5-digit ZIP code to identify the state of the user.

In addition to DTMF input, voice recognition can be used. Voice recognition software can be used to determine what a user has input. At present, voice recognition software works best where user input is restricted to a limited universe of possible answers (e.g., “yes” or “no”).

### Audio Output

In an automated system, output sent to the caller can done via sound files. .wav or .mp3 are choices, although .wav is preferred because it is a format that works well for spoken content.

In addition, there are known text-to-voice tools that can create sound output from data input. For example, “SAY” commands in Asterisk can be used to generate sounds. These text-to-voice tools essentially look up sound files corresponding to the letters or numbers involved and play them.

There are also known tools that pronounce words, rather than single letters. These can be used. One such example is available for demonstration purposes from AT&T research, available at http://www.rearch.att.com/˜ttsweb/tts/demo.php. Other text-to-speech “readers” include Festival, Flite, Reallspeak, NaturalReader, Acapela, Cepstral, VozMe, CalTrox's Speech Synthesizer, and others. Although these “readers” are not all intended for use on a server-side of an application, they can be customized or tailored.

### The Voice-Internet Connection

One aspect of the invention is the connection between the voice system and the PBX. Although much voice traffic (phone calls) is currently carried over the internet, and this share is steadily increasing, the present invention contemplates connecting voice information with internet information. For example, when a user registers for the course, the user information is entered into a database, this database may be housed on a server that is accessible via the internet. Similarly, it is anticipated that live customer service will be desired on rare occasions, and this live customer service may be located remotely from the phone system and the location of the database. By using a database that it housed on a server that is accessible from the internet, this can be facilitated.

It is well-known in the telephony art that a phone call can be terminated at a location that is accessible by the internet. In one example, a phone number can be associated with an IP address using DDI (DID). This connection can be made via SIP or IAX. The inventor has experimented with a connection using an account from IPKall.

Once a phone number is routed to an IP address, there must be something at that IP address that knows how to answer a phone and deal with the phone. Proprietary software exists that can be used for this. In addition, the open-source code Asterisk can be used for this. The inventor successfully installed Asterisk on a Linux system with virtually dedicated hosted by a hosting company named Mediatemple by following the installation directions in an O'Reilly book on Asterisk.

The above description describes a system whereby phone calls are terminated to a system using IP telephony. It is also possible to use a phone system that is linked to a server using a card. For example, a voice T1 line can be connected to a server using a Digium card. The inventor has also successfully implemented such a system. This server does not have to be on the internet to answer incoming calls, although it is desirable to link it to the internet to allow it to perform other functions such as: (1) sending calls out from the system, such as to customer service, (2) reading and writing to an external database, (3) accessing external website such as PACER or the EOUST certificate site, (4) sending faxes and emails, (5) submitting payment information and receiving response information to payment gateways.

### Server

The server that runs the PBX application (e.g., Asterisk/FreePBX) can be a traditional web server, such as one that runs Apache. The server should have enough memory to store sound files, if they are used, as well as be fast enough to handle many users at once.

PBX applications are designed to handle multiple users at once. Where this is the case, the telephone connection must be established to allow multiple callers to call-in to the system at once.

### Database Connection

A database can be used to store debtor information. The database can be housed on the server that performs the phone-answering, or it can be remote. A remote database may be housed on a remote server. For a remote database, it is possible to enable remote access by means of an approved userid and password and to allow the IP address of the remote user access.

Although the user has employed a MySQL database, any type of database can be used. In one embodiment of the invention, a database has a data table containing the following information for each user: name, whether payment has been made, bankruptcy case information (case number, judicial district), last four digits of social security number (for identity confirmation), progress (how much of the course has been completed), contact information (e.g., phone number, address, email address, fax number), lawyer information (name, address, fax number, email address), evaluation answers, method of course delivery (phone/internet/other).

A database can be queried using scripts. For example, Perl and php scripts easily submit queries to a database to insert, update, modify, drop, add, alter, select and perform other functions.

### Trees and Menus

The entire phone course can be illustrated in a schematic of trees and menus. These trees can be established in a variety of ways. The inventor created a partial replica of this course using a dialplan in Asterisk and using a variety of extensions and “Goto” techniques. Freeware that sits atop Asterisk, like FreePBX can also be used. In addition, proprietary software can be written that performs this function—such software may sit atop Asterisk or FreePBX, or it may be its own solution that is not based on either Asterisk or FreePBX. Such a system can be installed on a server, either a Linux or Unix or Microsoft server.

The inventor has supervised the production of a prototype of this system using four trees, each of which is one extension that is used in Asterisk. The extensions are: (1) main menu, (2) payment menu, (3) course menu, and (4) wrap-up menu. The main menu plays introductory materials, registers new users including an optional lookup for users in PACER, allows login for new users, and connects to the other modules, as necessary. The payment menu handles payment via electronic check and credit/debit card and interacts with a payment gateway in addition to the voice interface. The course menu plays the course content and updates the database as a user progresses through the course. The wrap-up menu handles course evaluations, can look up contact information for where to send a certificate in the database or using PACER, sends certificates using email and fax (which may be using a fax server or a myfax account), reads back certificate information (e.g., certificate number and where a certificate was sent), and sends to voicemail (currently the easiest way to accept email information). In addition, any of the menus may transfer to voicemail or customer service.

### Connection to Live Customer Service

There may be situations where a user wishes to speak with a customer service person for assistance. A break-out key (e.g., “0”) can be used where the user presses that key and is immediately transferred to customer service.

Such a transfer can be accomplished easily using a PBX application by having an outgoing extension (e.g., SIP). In this example, when a user presses “0”, (s)he is transferred to the outgoing extension which then connects to a customer service individual. This individual could be located remotely from the PBX application.

### Connection to Voice Mail

It may also be desirable to allow a user to leave a voicemail. For example, when a user desires to leave an email address where (s)he wants to have the certificate sent, the email address could be left in a voicemail because it is easier to enter an alphanumeric email address in voicemail than to enter via the keypad or via voice recognition. It may also be desirable for a user to leave comments in the form of a voicemail.

### Married Couples Seeking Education

Sometimes multiple individuals will seek education at the same time. A common such situation in the bankruptcy education universe is where a married couple has jointly filed for bankruptcy. The invention can easily address this case. The inventor has designed a system whereby married users can choose whether to take the course together or separately. If the users choose to take the course separately, each user will have separate access to the course. When a user enters the course, (s)he will proceed through the course on his/her own and his/her progress will be saved and a certificate created at the appropriate time. When the spouse takes the course, (s)he will separately hear the content and receive a separate certificate.

In the event that a married couple chooses to complete the course together, they will inform the system as much by answering a simple question (e.g., “Press 1 to take the course together, press 2 to take the course separately.”). After designating that they intend to take the course together, the course will proceed and at the end both spouses will receive their certificates. Under this scenario, however, spouses are required to both be present throughout the course and may have to enter identifying information to prove that they are present at all times.

### CONCLUSION

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. For example, the present invention can be modified for application to traffic school or continuing education. For traffic school, the appropriate records may be available at the DMV or on a ticket. For continuing education, records may be looked up at a state bar association.

1. A telephonic education delivery apparatus comprising:
a telephonic server operatively connected to a voice-internet connection and an internet protocol connection, and configured to terminate a telephone call made by a user over a traditional telephone line to request educational content, maintain user contact over the voice-internet connection, and communicate with one or more external sites operatively connected to the telephonic server over the internet protocol connection to execute tasks to complete delivery of the educational content;
a database environment configured to track and store user progress in completion of an education course; and
a plurality of modules resident on the telephonic server configured to execute tasks to complete delivery of the educational content, the plurality of modules including a first module configured to ascertain user court case information, a second module configured to communicate user information to a certificate-generating portal, a third module configured to communicate a certificate of completion to the user, and a fourth module to deliver the educational content over the voice-internet connection from the telephonic server to the user.

2. The apparatus of claim 1, wherein the educational content comprises at least one sound file, the at least one sound file played for the user over the voice-internet connection during delivery of the education content to the user.

3. The apparatus of claim 1, wherein the educational content is bankruptcy education.

4. The apparatus of claim 1, wherein at least the first module to ascertain user court case information and the second module to communicate user information to a certificate-generating portal in the plurality of modules are each configured to communicate with an external site in the one or more external sites operatively connected to the telephonic server.

5. The apparatus of claim 1, further comprising a payment module in the plurality of modules configured to communicate with a payment gateway over the internet protocol connection to enable a user to pay for the education course.

6. The apparatus of claim 1, wherein the database environment is operatively connected to the telephonic server, so that the telephonic server communicates with at least one database in the database environment on which user records for tracking and storing user progress are maintained over the internet protocol connection.

7. A method of aggregating information requested in a telephonic education course comprising:
terminating a telephone call placed by a user and transmitted over a voice-internet connection as an inbound educational course user call at a telephonic server while maintaining user contact over the voice-internet connection;
determining a data requirement of the inbound educational course user call from user input and interpreting the data requirement into an outbound request for completion of a task associated with delivering educational content to be communicated to at least one external site over a traditional internet connection;
storing and tracking user progress through the educational course; and
delivering the educational content to the user.

8. The method of claim 7, wherein said educational content is bankruptcy education.

9. The method of claim 7, wherein interpreting the data requirement into an outbound request for completion of a task further comprises accessing a database to track and save user progress.

10. The method of claim 7, wherein interpreting the data requirement into an outbound request for completion of a task further comprises enabling a user to process payment at a payment gateway to complete payment for the educational course.

11. The method of claim 7, further comprising storing the educational content in at least one sound file and playing the at least one sound file for the user over the voice-internet connection.

12. The method of claim 7, further comprising transmitting a certificate of completion to the user.

13. The method of claim 7, wherein interpreting the data requirement into an outbound request for completion of a task further comprises retrieving a case record associated with the user to ascertain user court case information.

14. The method of claim 7, wherein interpreting the data requirement into an outbound request for completion of a task further comprises accessing a site of a certification-generating portal to request a certificate of completion.

15. A method of administering a telephonic education course, comprising:
retrieving a user record and confirming a user court case for a user requesting an education course, initiated by the user placing a traditional telephone call, the traditional telephone converted to a voice-internet connection call while contact is maintained with the user;
delivering educational content to the user;
tracking and storing user progress at a database location;
generating a certificate of completion; and
routing, over a traditional internet connection, at least one request for completion of a task attendant to a user's completion of the education course.

16. The method of claim 15, further comprising transporting the voice-internet connection call to a telephonic server configured to terminate the voice-internet connection call and access at least one external site for routing, over the traditional internet connection, the least one request for completion of a task.

17. The method of claim 16, wherein routing, over a traditional internet connect, the at least one request for completion of a task further comprises enabling the user to process payment at a payment gateway.

18. The method of claim 15, wherein confirming a user court case for a user further comprises accessing a case record associated with the user from a user case record database.

19. The method of claim 18, wherein delivering the educational content to the user further comprises delivering at least one sound file by playing the at least one sound file for the user over the voice-internet connection.

20. The method of claim 15, wherein the educational content is bankruptcy education.

21. The method of claim 15, wherein generating a certificate of completion further comprises accessing a certificate-generating portal to retrieve a certificate of completion.

22. The method of claim 21, further comprising transmitting the certificate of completion to the user.
